(19) United States
(12) Patent Application Publication
(10) Pub. No.: US 2022/0250998 A1
(43) Pub. Date: Aug. 11, 2022

(54) METHOD FOR ENHANCING HYDROPONIC PLANT PRODUCTIVITY USING GLYCINE BETAINE

(71) Applicant: DANSTAR FERMENT AG, Zug (CH)

(72) Inventor: Thomas DOUTRELUINGNE, Lambersart (FR)

(73) Assignee: DANSTAR FERMENT AG, Zug (CH)

(21) Appl. No.: 17/624,543

(22) PCT Filed: Jul. 3, 2020
(86) PCT No.: PCT/EP2020/068816

§ 371 Date: Jan. 3, 2022

(30) Foreign Application Priority Data
Jul. 4, 2019 (EP) 19290050.4

(51) Int. Cl. C05C 11/00; C05G 5/23; A01G 31/00; A01G 22/15

(52) U.S. Cl. CPC C05C 11/00; A01G 22/15; A01G 31/00; C05G 5/23

(57) ABSTRACT

The present disclosure provides a new method for enhancing plant productivity and/for reducing leaf necrosis of plant grown hydroponically by using glycine betaine.

### TECHNOLOGICAL FIELD

The present disclosure relates to a method for enhancing the productivity of plants grown in hydroponic growth medium and/or for reducing leaf necrosis in plants grown hydroponically by using glycine betaine.

### BACKGROUND

Hydroponics is defined as a method and a system of growing plants and other vegetation without the use of soil. The hydroponic systems are designed to deliver a nutritive or nutrient solution to the plants at a controlled and predictable rate periodically. The delivery of the nutritive solution to the plants at controlled growth conditions of nutrition, light, water, temperature, etc, causes an accelerated plant growth within the limited spaces.

The most popular food crops for hydroponic production are tomatoes, lettuces, cucumbers, greens, peppers, eggplants, strawberries, herbs, microgreens and shoots. Plants from Cichorium intybus L species, also called endives or witloof chicory, can also be grown hydroponically during second stages of production. Usually the first stage of production is done out in the field from spring to fall. The second stage involves stacking the bare, clean chicory roots into hydroponic trays, through which nutrient solution flows. More particularly, the cultivation, for a 21 day forcing, comprises growing endives in tubs containing a nutrient solution brought to a temperature from about 18° C. to about 21° C. and an air temperature of about 1° C. to 3° C. lower than the nutrient solution temperature. This process takes place entirely in the dark so that the shoots that form on the roots are blanched white in colour with the outer edge of the leaves only having a slight yellow color. The white buds (called chicons) are harvested at a certain stages, depending on market size requirements, and packaged into cartons to maintain complete darkness.

Among factors affecting hydroponic production systems, the nutrient solution is considered to be one of the most important determining factors of crop yield and quality. The most basic nutrient solutions consider in its composition only nitrogen, phosphorus, potassium, calcium, magnesium and sulphur and they are supplemented with micronutrients. Too much nitrogen in a nutrient solution will cause the following symptoms on plants: overall suppression of growth, leaf chlorosis, and reduction in root/shoot ratio with particular inhibition of fine roots. There can also be a buildup of nitrites in the plant tissue that can cause the plants to be more susceptible to disease but can also be harmful to the animals, including humans, who eat the plants. Furthermore, it is well known that an overuse of synthetic nutrients, as for example, inorganic nitrates, phosphates and the like compounds and also there inefficient use are major factors responsible for environmental problems such as eutrophication of groundwater, nitrate pollution, phosphate pollution and the like.

In order to mitigate the problems associated with inefficient use and overuse of nutrients, there is a continuing desire and need for environmental and production reasons to increase fertilizer efficiency and improve plant productivity. Therefore, there is a need in the state of the art to develop alternative hydroponic methods to those already existing for increasing the plant biomass and/or for reducing leaf necrosis and with it, the crop yield, which do not have the aforementioned drawbacks.

### BRIEF SUMMARY

The present disclosure is directed to the development and the use of a new hydroponic nutrient solution composition which reduces or eliminates the needs of an ammoniacal nitrogen source or a nitrate nitrogen source without compromising plant yield, without affecting growth performance of a plant and/or without affecting plant health.

The present invention relates to the use of glycine betaine as an organic nitrogen source in a hydroponic nutrient solution.

The present invention provides a method for reducing leaf necrosis of a plant comprising supplying to a plant in a hydroponic nutrient solution an effective amount of glycine betaine. In an embodiment, the hydroponic nutrient solution comprises one or more nutrients and said glycine betaine is incorporated as an additive to supplement the one or more nutrients in the hydroponic nutrient solution which feeds the plant in a hydroponic system. In an alternative embodiment, the glycine betaine is the sole nutrient in the hydroponic nutrient solution, preferably wherein the hydroponic nutrient solution consists of water and glycine betaine.

In certain embodiments of the above described method for reducing leaf necrosis of a plant, the glycine betaine is in partial or total replacement of an inorganic nitrogen source in the hydroponic nutrient solution and said reduction of leaf necrosis is equivalent or superior as compared to a plant cultivated with a nutrient solution comprising an inorganic nitrogen source alone in absence of glycine betaine. Said amount of inorganic nitrogen source in the hydroponic nutrient solution may be reduced by from 0.01% to 100% and replaced by an equivalent amount of glycine betaine in terms of nitrogen supplied, optionally said amount of inorganic nitrogen source in the hydroponic solution is reduced by at least about 0.01%, at least about 0.1%, at least about 0.5%, at least about 1%, at least about 2% at least about 3%, at least about 4%, at least about 5%, at least about 6%, at least about 7%, at least about 8%, at least about 9%, at least about 10%, at least about 15%, at least about 20%, at least about 25%, at least about 30%, at least about 35, at least about 40%, at least about 45%, at least about 50%, at least about 55%, at least about 60%, at least about 65%, at least about 70%, at least about 75%, at least about 80%, at least about 85%, at least about 90%, at least about 95% or in totality.

In certain embodiments of the above described method for reducing leaf necrosis of a plant, said leaf necrosis is reduced by at least 0.1%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, or more than 90% compared to a plant cultivated with a nutrient solution comprising an inorganic nitrogen source alone in absence of glycine betaine.

The present invention also provides a method for enhancing plant productivity comprising supplying to a plant in a hydroponic nutrient solution a productivity enhancing amount of glycine betaine. In an embodiment, the hydroponic nutrient solution comprises one or more nutrients and said glycine betaine is incorporated as an additive to supplement the one or more nutrients in the hydroponic nutrient solution which feeds the plant in a hydroponic system. In an alternative embodiment, the glycine betaine is the sole nutrient in the hydroponic nutrient solution, preferably the hydroponic nutrient solution consists of water and glycine betaine.

In certain embodiments of the above described method for enhancing plant productivity, said glycine betaine is in partial or total replacement of an inorganic nitrogen source in the hydroponic nutrient solution and said plant productivity is equivalent or superior as compared to a plant cultivated with a nutrient solution comprising an inorganic nitrogen source alone in absence of glycine betaine. Said amount of inorganic nitrogen source in the hydroponic nutrient solution is reduced by from 0.1% to 100% and replaced by an equivalent amount of glycine betaine in terms of nitrogen supplied, optionally said amount of inorganic nitrogen source in the hydroponic solution is reduced by at least about 0.1%, at least about 0.5%, at least about 1%, at least about 2% at least about 3%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95% or in totality.

In certain embodiments of the above described method for enhancing plant productivity, said plant productivity is enhanced by at least 0.1%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, or more than 90% compared to a plant cultivated with a nutrient solution comprising an inorganic nitrogen source alone in absence of glycine betaine.

In certain embodiments of the above described methods, said plant is a leafy vegetable, preferably said plant is an endive or chicory. In certain embodiments of the above described methods, wherein said glycine betaine is incorporated in the hydroponic nutrient solution during a forcing process. In certain embodiments of the above described methods, said glycine betaine is incorporated in the hydroponic nutrient solution in a concentration of between 0.75 meq/L to 20 meq/L (85 mg/L to 2350 mg/L), preferably between 0.75 meq/L to 7 meq/L (85 mg/L to 820 mg/L).

The present invention further provides the use of glycine betaine in a hydroponic nutrient solution to enhance plant productivity and/or to reduce leaf necrosis, wherein: (a) the hydroponic nutrient solution comprises one or more nutrients and said glycine betaine is incorporated as an additive to supplement the one or more nutrient in the hydroponic nutrient solution which feeds the plant in a hydroponic system; or (b) the glycine betaine is the sole nutrient in the hydroponic nutrient solution, preferably wherein the hydroponic nutrient solution consists of water and glycine betaine, and wherein the plant productivity is enhanced as compared to a plant cultivated with a nutrient solution comprising an inorganic nitrogen source alone in absence of glycine betaine and/or the leaf necrosis is reduced as compared to a plant cultivated with a nutrient solution comprising an inorganic nitrogen source alone in absence of glycine betaine.

Also provided by the present invention is the use of glycine betaine in a hydroponic nutrient solution to enhance plant productivity and/or to reduce leaf necrosis, wherein said glycine betaine is in partial or total replacement of an inorganic nitrogen source in a hydroponic nutrient solution and wherein the plant productivity is enhanced as compared to a plant cultivated with a nutrient solution comprising an inorganic nitrogen source in absence of glycine betaine and/or the leaf necrosis is reduced as compared to a plant cultivated with a nutrient solution comprising an inorganic nitrogen source alone in absence of glycine betaine.

In certain embodiments of the above described uses, said use is to reduce leaf necrosis. In certain embodiments of the above described uses, said use is enhance plant productivity. In certain embodiments of the above described uses, said plant is a leafy vegetable, preferably said plant is an endive or chicory. In certain embodiments of the above described uses, said glycine betaine is incorporated in the hydroponic nutrient solution during a forcing process. In certain embodiments of the above described uses, said glycine betaine is incorporated in the hydroponic nutrient solution in a concentration of between 0.75 meq/L to 20 meq/L (85 mg/L to 2350 mg/L), preferably between 0.75 meq/L to 7 meq/L (85 mg/L to 820 mg/L).

### DETAILED DESCRIPTION

It has been surprisingly discovered that the substitution, partial or total, of a mineral or an inorganic nitrogen source (as, for example, an ammoniacal nitrogen source or a nitrate nitrogen source) in a hydroponic nutrient solution with glycine betaine, as an organic nitrogen source and derived from a natural organic source, provides an effect on plant productivity or plant yield which is equivalent or superior to that obtained using a hydroponic nutrient solution comprising a mineral or an inorganic nitrogen source alone in absence of glycine betaine while eliminating the disadvantages associated with the use of a mineral or an inorganic nitrogen source.

The present disclosure is directed to a method for enhancing plant productivity or plant yield in a hydroponic medium or hydroponic nutrient solution. Enhanced plant productivity or plant yield is achieved by replacing or substituting (partially or totally) the mineral or inorganic nitrogen source in a hydroponic nutrient solution with glycine betaine. In another embodiment, the method for enhancing plant productivity or plant yield is achieved by adding or incorporating glycine betaine to a hydroponic nutrient solution in addition to an inorganic nitrogen source.

Additionally, the present disclosure is directed to the use of glycine betaine in a hydroponic nutrient solution during the forcing period or forcing process to enhance plant productivity of leafy vegetables, for example endive or chicory. More particularly, the present disclosure is directed to a method of hydroponically forcing endive or chicory comprising the use of glycine betaine in addition or in replacement (in part or total) of an inorganic nitrogen source in a hydroponic nutrient solution. The method of the present disclosure improves the yield of endive or chicory compared to the yield obtained using a hydroponic nutrient solution comprising an inorganic nitrogen source alone in absence of glycine betaine during the forcing process.

It has also been surprisingly discovered that the use of glycine betaine in a hydroponic nutrient solution during the forcing period or forcing process is surprisingly effective in reducing leaf necrosis of leafy vegetables, for example endive or chicory. More particularly, the present disclosure is directed to the use of glycine betaine in addition or in replacement (partially or totally) of an inorganic nitrogen source in a hydroponic nutrient solution to reduce foliar necrosis as compared with the use of a hydroponic nutrient solution comprising an inorganic nitrogen source alone in absence of glycine betaine during the forcing process. In a preferred embodiment, the use of glycine betaine is for reducing necrosis at the outer edge of an endive leaf.

In an embodiment, the use of glycine betaine enables a reduction of the nitrogen levels in the hydroponic nutrient solution without reducing the nitrogen nutrition of the host plants. Alternatively, the nitrogen supply by glycine betaine is not reduced in terms of principle or unity required but the concentration can be further adjusted depending on the particular crop absorption rate.

As used herein, the term “a mineral or an inorganic nitrogen source” means any forms that include nitrate (NO₃), nitrite (NO₂), ammonia (N H₃), and nitrogen gas (N₂).

As used herein, the term “effective amount” means an amount sufficient to cause the referenced effect or outcome. For example, in the context of a method for reducing leaf necrosis of a plant described herein, an effective amount of glycine betaine is an amount sufficient to reduce leaf necrosis of the plant. Similarly, in the context of a method for enhancing plant productivity described herein, an effective amount of glycine betaine is an amount sufficient to enhance plant productivity. An “effective amount” can be determined empirically and in a routine manner using known techniques in relation to the stated purpose.

As used herein, the term “enhanced, improved or increased plant productivity” means any improvement in the yield of any measured plant product, such as grain, fruit or fiber in comparison to the yield of a plant cultivated with a hydroponic nutrient solution comprising an inorganic nitrogen source alone in absence of glycine betaine. For example, and without limitation, parameters such as increased growth rate, increased biomass, harvest index and accelerated rate of root formation are suitable measurements of improved yield. Any increase in yield is an improved yield in accordance with the invention. For example, the improvement or increase in yield can comprise at least 0.1%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90% or greater increase in any measured parameter compared to plant cultivated with a hydroponic nutrient solution comprising an inorganic nitrogen source alone in absence of glycine betaine. For example, enhanced, improved or increased “yield” refers to one or more yield parameters selected from the group consisting of biomass yield, dry biomass yield, aerial dry biomass yield, underground dry biomass yield, fresh-weight biomass yield, aerial fresh-weight biomass yield, underground fresh-weight biomass yield, enhanced yield of harvestable parts, either dry or fresh-weight or both, either aerial or underground or both. In other words, the “plant biomass” is often measured as the dry mass or weight (or “fresh weight” where appropriate) of the plant. A non-limiting example of a parameter that can be used to determine the growth of the plant biomass of a plant includes: the dry matter (DM) or the dry plant weight to fresh plant weight ratio. It is expressed in kg (dry weight) kg⁻¹ (fresh weight).

As used herein, the term “reducing leaf necrosis” means any noticeable decreases in leaf senescence, chlorosis or necrosis (i.e. tissue death) as compared with plant cultivated with a hydroponic nutrient solution comprising an inorganic nitrogen source alone in absence of glycine betaine. For example, leaf necrosis is reduced by at least 0.1%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, or more than 90% compared to plant cultivated with a hydroponic nutrient solution comprising an inorganic nitrogen source alone in absence of glycine betaine.

The method of the present disclosure can be applied to any types of plant that grow well in hydroponic systems as, for example, but not limited to, most house plants, flowering plants, vegetables (such as leafy vegetables), many types of fruits and an endless variety of herbs for seasoning or medicinal purposes. Examples of plants include, but are not limited to, artichokes, asparagus, beans, beets, broccoli, Brussels sprouts, cabbages, carrots, cauliflowers, celery, chicory, cucumber, eggplants, endives, leeks, lettuce, onions, parsnips, peas, potatoes, radishes, rhubarb, squash, tomatoes, yams, watermelon, cantaloupe, tomatoes, peppers, strawberries, blueberries, blackberries, raspberries, grapes, arugula, basil, chervil, chives, coriander, dill, lemon balm, mache, marjoram, oregano, rosemary, sorrel, spear and peppermint, sage, tarragon and thyme. In an embodiment, the plant is a leafy vegetable such as lettuce, endive or chicory. In a preferred embodiment, the plant is an endive or a chicory.

In an embodiment, the glycine betaine used in the present disclosure as a source of nitrogen is incorporated as an additive to supplement a hydroponic nutrient solution or nutritive solution fed to the plant in a hydroponic system or, in another particular embodiment, the glycine betaine can be directly administered to the water or irrigation water of said plant. In another embodiment, the glycine betaine is in partial or total replacement or substitution of an inorganic nitrogen source in a hydroponic nutrient solution. Glycine betaine in the hydroponic nutrient solution is in contact with the roots of a plant grown hydroponically. Hydroponically grown plants are grown in a nutrient solution, and the plant may be supported in this solution by inert mediums such as perlite, gravel or mineral wool. As used herein, a “hydroponic nutrient solution” refers to a solution that comprises a plant's nutritionally required nutrients. Typically, the hydroponic solution comprises inorganic ions that are essential for the plant to survive, including those that provide one or more of the following elements: nitrogen, phosphorus, potassium, calcium, magnesium, sulfur, boron, chlorine, iron, manganese, zinc, copper and nickel. The solution may comprise sources of any combination of these elements (e.g. all 13 elements, or 2 to 13, 4 to 13, 7 to 13, or 10 to 13 of the elements). Preferred solutions comprise sources of at least nitrogen and phosphorous. Alternatively, glycine betaine can be directly added to water without the addition of other nutrients. Accordingly, in some embodiments, the hydroponic nutrient solution may comprise glycine betaine as the sole nutrient. In an embodiment, the hydroponic solution consist of, or essentially consists of, water and glycine betaine. Furthermore, glycine betaine can be added to a water solution or an incomplete water solution which is a source of water that does not comprise all of the mineral nutrients required by plants.

In a preferred embodiment, it is the ammoniacal nitrogen fraction of the hydroponic nutrient solution that is replaced, totally or partially, by glycine betaine.

In an embodiment, the glycine betaine is incorporated in the hydroponic nutrient solution during a forcing process or a forcing period. As known in the art and used herein, the “forcing process or forcing period” consists in forcing a plant to grow by subjecting it to conditions of temperature and humidity. The forcing is usually performed by taking the bulbs or roots of the plants, keeping the bulbs or roots at low temperature for a certain period of time, and finally forcing the development of the bulbs or roots by changing the environmental conditions to warm and humid. Forcing can be done in hydroponic culture in various types of substrates, hydroponic nutrient solutions or even in water. A typical leafy vegetable normally subjected to a period or process of forcing is the endive or chicory. In a preferred embodiment, the glycine betaine is incorporated in the hydroponic nutrient solution during a forcing process or a forcing period of the endive or the chicory.

In an embodiment, the amount of mineral or inorganic nitrogen source or the ammoniacal nitrogen fraction is reduced by from 0.01% to 100% and replace, by an equivalent amount of glycine betaine in terms of nitrogen supplied. More particularly, the amount of the mineral or inorganic nitrogen source or the ammoniacal nitrogen fraction is reduced by at least about 0.01%, at least about 0.05%, at least about 0.1%, at least about 0.5%, at least about 1%, at least about 1.5%, at least about 2%, at least about 2.5%, at least about 3%, at least about 3.5%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95% or in totality. In an embodiment, the amount of mineral or inorganic nitrogen source or the ammoniacal nitrogen fraction is reduced by from 0.01% to 60% and replace, by an equivalent amount of glycine betaine in terms of nitrogen supplied. In a preferred embodiment, the amount of mineral or inorganic nitrogen source or the ammoniacal nitrogen fraction is reduced by from 0.01% to 40% and replace, by an equivalent amount of glycine betaine in terms of nitrogen supplied.

In an embodiment, the concentration of glycine betaine supplied to the hydroponic nutrient solution is at least about 0.20 meq/L, 0.25 meq/l, 0.30 meq/L, 0.35 meq/L, 0.40 meq/L, 0.45 meq/L, 0.50 meq/l, 0.55 meq/L. 0.60 meq/L, 0.65 meq/L, 0.70 meq/L, 0.75 meq/L, 0.80 meq/L, 0.85 meq/L, 0.90 meq/L, 0.95 meq/L, 1 meq/L, 1.1 meq/L, 1.2 meq/L, 1.3 meq/L, 1.4 meq/L, 1.5 meq/L, 1.6 meq/L, 1.7 meq/L, 1.8 meq/L, 1.9 meq/L, 2 meq/L, 2.1 meq/L, 2.2 meq/L, 2.3 meq/L, 2.4 meq/L, 2.5 meq/L, 2.6 meq/L, 2.7 meq/L, 2.8 meq/L, 2.9 meq/L, 3 meq/L, 3.1 meq/L, 3.2 meq/L, 3.3 meq/L, 3.4 meq/L, 3.5 meq/L, 3.6 meq/L, 3.7 meq/L, 3.8 meq/L, 3.9 meq/L, 4 meq/L, 4.1 meq/L, 4.2 meq/L, 4.3 meq/L, 4.4 meq/L, 4.5 meq/L, 4.6 meq/L, 4.7 meq/L, 4.8 meq/L, 4.9 meq/L, 5 meq/L, 5.1 meq/L, 5.2 meq/L, 5.3 meq/L. 5.4 meq/L, 5.5 meq/L, 5.6 meq/L, 5.7 meq/L, 5.8 meq/L, 5.9 meq/L, 6 meq/L, 6.1 meq/L, 6.2 meq/L, 6.3 meq/L, 6.4 meq/L, 6.5 meq/L, 6.6 meq/L, 6.7 meq/L, 6.8 meq/L, 6.9 meq/L, 7 meq/L, 8 meq/L, 9 meq/L, 10 meq/L, 11 meq/L, 12 meq/L, 13 meq/L, 14 meq/L, 15 meq/L, 16 meq/L, 17 meq/L, 18 meq/L, 19 meq/L, 20 meq/L, 21 meq/L, 22 meq/L, 23 meq/L, 24 meq/L, 25 meq/L, 26 meq/L, 27 meq/L, 28 meq/L, 29 meq/L or 30 meq/L, 35 meq/L, 40 meq/L, 45 meq/L, 50 meq/L, 55 meq/L, 60 meq/L, 65 meq/L, 70 meq/L, 75 meq/L, 80 meq/L, 85 meq/L, 90 meq/L, 95 meq/L or more than 100 meq/L.

In an embodiment, glycine betaine is incorporated in the hydroponic nutrient solution at a concentration of least about 0.20 meq/L, 0.25 meq/l, 0.30 meq/L, 0.35 meq/L, 0.40 meq/L, 0.45 meq/L, 0.50 meq/l, 0.55 meq/L. 0.60 meq/L, 0.65 meq/L, 0.70 meq/L, 0.75 meq/L, 0.80 meq/L, 0.85 meq/L, 0.90 meq/L, 0.95 meq/L, 1 meq/L, 1.1 meq/L, 1.2 meq/L, 1.3 meq/L, 1.4 meq/L, 1.5 meq/L, 1.6 meq/L, 1.7 meq/L, 1.8 meq/L, 1.9 meq/L, 2 meq/L, 2.1 meq/L, 2.2 meq/L, 2.3 meq/L, 2.4 meq/L, 2.5 meq/L, 2.6 meq/L, 2.7 meq/L, 2.8 meq/L, 2.9 meq/L, 3 meq/L, 3.1 meq/L, 3.2 meq/L, 3.3 meq/L, 3.4 meq/L, 3.5 meq/L, 3.6 meq/L, 3.7 meq/L, 3.8 meq/L, 3.9 meq/L, 4 meq/L, 4.1 meq/L, 4.2 meq/L, 4.3 meq/L, 4.4 meq/L, 4.5 meq/L, 4.6 meq/L, 4.7 meq/L, 4.8 meq/L, 4.9 meq/L, 5 meq/L, 5.1 meq/L, 5.2 meq/L, 5.3 meq/L. 5.4 meq/L, 5.5 meq/L, 5.6 meq/L, 5.7 meq/L, 5.8 meq/L, 5.9 meq/L, 6 meq/L, 6.1 meq/L, 6.2 meq/L, 6.3 meq/L, 6.4 meq/L, 6.5 meq/L, 6.6 meq/L, 6.7 meq/L, 6.8 meq/L, 6.9 meq/L, 7 meq/L, 8 meq/L, 9 meq/L, 10 meq/L, 11 meq/L, 12 meq/L, 13 meq/L, 14 meq/L, 15 meq/L, 16 meq/L, 17 meq/L, 18 meq/L, 19 meq/L, 20 meq/L, 21 meq/L, 22 meq/L, 23 meq/L, 24 meq/L, 25 meq/L, 26 meq/L, 27 meq/L, 28 meq/L, 29 meq/L or 30 meq/L, 35 meq/L, 40 meq/L, 45 meq/L, 50 meq/L, 55 meq/L, 60 meq/L, 65 meq/L, 70 meq/L, 75 meq/L, 80 meq/L, 85 meq/L, 90 meq/L, 95 meq/L or more than 100 meq/L.

In an embodiment, the concentration of glycine betaine supplied to the hydroponic nutrient solution is between 0.75 meq/L to 20 meq/L. In a preferred embodiment, the concentration of glycine betaine supplied to the hydroponic nutrient solution is between 0.75 meq/L to 10 meq/L. In a more preferred embodiment, the concentration of glycine betaine supplied to the hydroponic solution is between 0.75 meq/L to 7 meq/L. Preferably, the concentration of glycine betaine supplied to the hydroponic nutrient solution is between 0.75 meq/L to 4 meq/L.

In an embodiment, glycine betaine is incorporated in the hydroponic nutrient solution at a concentration between 0.75 meq/L to 20 meq/L. In a preferred embodiment, glycine betaine is incorporated in the hydroponic nutrient solution at a concentration between 0.75 meq/L to 10 meq/L. In a more preferred embodiment, glycine betaine is incorporated in the hydroponic nutrient solution at a concentration 0.75 meq/L to 7 meq/L. In an even more preferred embodiment, glycine betaine is incorporated in the hydroponic nutrient solution at a concentration between 0.75 meq/L to 4 meq/L.

In an embodiment, glycine betaine is supplied to the hydroponic nutrient solution at a concentration of at least about 20 mg/L, 25 mg/L, 30 mg/L, 35 mg/L, 40 mg/L, 45 mg/L, 50 mg/L, 55 mg/L, 60 mg/L, 65 mg/L, 70 mg/L, 75 mg/L, 80 mg/L, 85 mg/L, 90 mg/L, 95 mg/L, 100 mg/L, 110 mg/L, 120 mg/L, 130 mg/L, 140 mg/L, 150 mg/L, 160 mg/L, 170 mg/L, 180 mg/L, 190 mg/L, 200 mg/L, 210 mg/L, 220 mg/L, 230 mg/L, 240 mg/L, 250 mg/L, 260 mg/L, 270 mg/L, 280 mg/L, 290 mg/L, 300 mg/L, 310 mg/L, 320 mg/L, 330 mg/L, 340 mg/L, 350 mg/L, 360 mg/L, 370 mg/L, 380 mg/L, 390 mg/L, 400 mg/L, 410 mg/L, 420 mg/L, 430 mg/L, 440 mg/L, 450 mg/L, 460 mg/L, 470 mg/L, 480 mg/L, 490 mg/L, 500 mg/L, 510 mg/L, 520 mg/L, 530 mg/L, 540 mg/L, 550 mg/L, 560 mg/L, 570 mg/L, 580 mg/L, 590 mg/L, 600 mg/L, 610 mg/L, 620 mg/L, 630 mg/L, 640 mg/L, 650 mg/L, 660 mg/L, 670 mg/L, 680 mg/L, 690 mg/L, 700 mg/L, 710 mg/L, 720 mg/L, 730 mg/L, 740 mg/L, 750 mg/L, 760 mg/L, 770 mg/L, 780 mg/L, 790 mg/L, 800 mg/L, 810 mg/L, 820 mg/L, 830 mg/L, 840 mg/L, 850 mg/L, 860 mg/L, 870 mg/L, 880 mg/L, 890 mg/L, 900 mg/L, 910 mg/L, 920 mg/L, 930 mg/L, 940 mg/L, 950 mg/L, 960 mg/L, 970 mg/L, 980 mg/L, 990 mg/L, 1000 mg/L, 1100 mg/L, 1200 mg/L, 1300 mg/L, 1400 mg/L, 1500 mg/L, 1600 mg/L, 1700 mg/L, 1800 mg/L, 1900 mg/L, 2000 mg/L, 2100 mg/L, 2200 mg/L, 2300 mg/L, 2400 mg/L, 2500 mg/L, 2600 mg/L, 2700 mg/L, 2800 mg/L, 2900 mg/L, 3000 mg/L, 3100 mg/L, 3200 mg/L, 3300 mg/L, 3400 mg/L, 3500 mg/L, 3600 mg/L, 3700 mg/L, 3800 mg/L, 3900 mg/L, 4000 mg/L, 4500 mg/L, 5000 mg/L, 5500 mg/L, 6000 mg/L, 6500 mg/L, 7000 mg/L, 7500 mg/L, 8000 mg/L, 8500 mg/L, 9000 mg/L, 9500 mg/L, 10 000 mg/L, 10 500 mg/L, 11 000 mg/L or more than 12 000 mg/L.

In an embodiment, glycine betaine is incorporated the hydroponic nutrient solution at a concentration of at least about 20 mg/L, 25 mg/L, 30 mg/L, 35 mg/L, 40 mg/L, 45 mg/L, 50 mg/L, 55 mg/L, 60 mg/L, 65 mg/L, 70 mg/L, 75 mg/L, 80 mg/L, 85 mg/L, 90 mg/L, 95 mg/L, 100 mg/L, 110 mg/L, 120 mg/L, 130 mg/L, 140 mg/L, 150 mg/L, 160 mg/L, 170 mg/L, 180 mg/L, 190 mg/L, 200 mg/L, 210 mg/L, 220 mg/L, 230 mg/L, 240 mg/L, 250 mg/L, 260 mg/L, 270 mg/L, 280 mg/L, 290 mg/L, 300 mg/L, 310 mg/L, 320 mg/L, 330 mg/L, 340 mg/L, 350 mg/L, 360 mg/L, 370 mg/L, 380 mg/L, 390 mg/L, 400 mg/L, 410 mg/L, 420 mg/L, 430 mg/L, 440 mg/L, 450 mg/L, 460 mg/L, 470 mg/L, 480 mg/L, 490 mg/L, 500 mg/L, 510 mg/L, 520 mg/L, 530 mg/L, 540 mg/L, 550 mg/L, 560 mg/L, 570 mg/L, 580 mg/L, 590 mg/L, 600 mg/L, 610 mg/L, 620 mg/L, 630 mg/L, 640 mg/L, 650 mg/L, 660 mg/L, 670 mg/L, 680 mg/L, 690 mg/L, 700 mg/L, 710 mg/L, 720 mg/L, 730 mg/L, 740 mg/L, 750 mg/L, 760 mg/L, 770 mg/L, 780 mg/L, 790 mg/L, 800 mg/L, 810 mg/L, 820 mg/L, 830 mg/L, 840 mg/L, 850 mg/L, 860 mg/L, 870 mg/L, 880 mg/L, 890 mg/L, 900 mg/L, 910 mg/L, 920 mg/L, 930 mg/L, 940 mg/L, 950 mg/L, 960 mg/L, 970 mg/L, 980 mg/L, 990 mg/L, 1000 mg/L, 1100 mg/L, 1200 mg/L, 1300 mg/L, 1400 mg/L, 1500 mg/L, 1600 mg/L, 1700 mg/L, 1800 mg/L, 1900 mg/L, 2000 mg/L, 2100 mg/L, 2200 mg/L, 2300 mg/L, 2400 mg/L, 2500 mg/L, 2600 mg/L, 2700 mg/L, 2800 mg/L, 2900 mg/L, 3000 mg/L, 3100 mg/L, 3200 mg/L, 3300 mg/L, 3400 mg/L, 3500 mg/L, 3600 mg/L, 3700 mg/L, 3800 mg/L, 3900 mg/L, 4000 mg/L, 4500 mg/L, 5000 mg/L, 5500 mg/L, 6000 mg/L, 6500 mg/L, 7000 mg/L, 7500 mg/L, 8000 mg/L, 8500 mg/L, 9000 mg/L, 9500 mg/L, 10 000 mg/L, 10 500 mg/L, 11 000 mg/L or more than 12 000 mg/L.

In an embodiment, the concentration of glycine betaine supplied to the hydroponic nutrient solution is between 85 mg/L to 2350 mg/L. In a preferred embodiment, the concentration of glycine betaine supplied to the hydroponic solution is between 85 mg/L to 1200 mg/L. In a more preferred embodiment, the concentration of glycine betaine supplied to the hydroponic solution is between 85 mg/L to 820 mg/L. Preferably, the concentration of glycine betaine supplied to the hydroponic solution is between 85 mg/L to 450 mg/L.

In an embodiment, glycine betaine is incorporated in the hydroponic nutrient solution at a concentration between 85 mg/L to 2350 mg/L. In a preferred embodiment, glycine betaine is incorporated in the hydroponic nutrient solution at a concentration between 85 mg/L to 1200 mg/L. In a more preferred embodiment, glycine betaine is incorporated in the hydroponic nutrient solution at a concentration 85 mg/L to 820 mg/L. In an even more preferred embodiment, glycine betaine is incorporated in the hydroponic nutrient solution at a concentration between 85 mg/L to 450 mg/L.

The glycine betaine incorporated in the hydroponic nutrient solution can be applied to the plant once every day or every other day during the forcing period.

Glycine-betaine extracted from sugar beet is commercially available for example under the trademark of IntraCell®, Greenstim®, Bluestim® or Osmopro® (Lallemand). Other betaine products, such as betaine monohydrate, betaine hydrochloride and raw betaine liquids, are also commercially available and they can be used for the purposes of the present disclosure. In general, glycine betaine can be supplied to the plant in a hydroponic nutrient solution in the form of aqueous liquids or in water-soluble substantially solid form.

The word “comprising” in the claims may be replaced by “consisting essentially of” or with “consisting of,” according to standard practice in patent law.

The following example serves to further describe and define the invention, and is not intended to limit the invention in any way.

### Example

The objective of the trials described below was to evaluate the effect of glycine betaine applied during the forcing process on endives on the quality of root preservation, the yield of chicons and the quality of preservation of chicons.

Trial 1:

Endives (Cichorium intybus variety Baccara (Hoquet), late type and highly demanding in N requirement) were forced in a hydroponic nutrient solution. Glycine betaine (Greenstim®-97% of glycine betaine, Lallemand) was incorporated in the hydroponic nutrient solution in replacement of the ammoniacal nitrogen source at a rate of 3.3 meq/L or 387 mg/L (formula C₅H₁₁NO₂−MM=117.2). The percentage of glycine betaine in nitrogen contribution is 16.52%. Endives were also forced in a standard hydroponic solution (without glycine betaine) as a control. Forcing room air temperature was between 13 and 17.5° C. while the hydroponic nutrient solution temperature was between 15 and 18.5° C.

The composition (in meq/l) of the hydroponic nutrient solution used in the present study was as followed: 18.3 nitrate, 3.3 ammonium, 7.5 potassium, 9 calcium, 2 sulfate and 1.5 magnesium.

A completely random block design with four repetitions was used. A heated water-bath with one vat per treatment was used.

Dry matter content of the roots during lifting and in the course of storage, chicon yields by commercial categories, susceptibility of chicons to post-harvest degradation after storage at 20° C. were evaluated. Edging, reddening and axis growth were evaluated ten days after storage in air. Bacterial disease was evaluated after 10 and 14 days of storage in closed bags.

Statistical comparisons were made by analysis of variance (one-way ANOVA) followed by a Tukey-Kramer post-test. P-values of <0.05 indicated statistical significance.

Results of trial 1:

The application of glycine betaine at forcing results in a non-significant improvement in average gross yields but a significant increase in net and Extra+1 (category Extra and class 1) yields compared to the average of untreated controls with +6% and +9.3% respectively (Table 1).

TABLE 1
Average net and Extra + 1 yields of chicons for 10 m² in field
per treatment option at forcing.

| Treatment at | | | |
|---|---|---|---|
| forcing | Gross (Kg) | Net (kg) | E + I (kg) |
| Control | 45.2 | 38.1 b | 29.3 b |
| Glycine betaine | 47.3 | 40.4 a | 32.0 a |
| Test F (5%) | NS | S | S |
| CV (%) | 7 | 6 | 7 |

The post-harvest degradations were also evaluated.
Reddening/blushing

Results indicate that the application of glycine betaine at forcing is accompanied by a slight but significant decrease in chicon susceptibility to postharvest reddening/blushing (Table 2).

TABLE 2
Sensitivity to reddening/blushing on a scale of 0 to 5.

| | | Treatment at forcing | |
|---|---|---|---|
| Nitrogen | Treatment in the | | Glycine |
| Fertilisation | vegetative phase | Control | betaine |
| Control | Control | 3.4 | 3.0 |
| | GS | 3.2 | 2.6 |
| Nitrogen | Control | 3.0 | 2.9 |
| | GS | 3.2 | 3.1 |
| Average | | 3.2 a | 2.9 b |

| | |
|---|---|
| Test F (5%) | S |
| CV (%) | 10 |

The application of glycine betaine at forcing (partially replacing the ammoniacal fraction in the hydroponic nutrient solution) was accompanied by a significant gain in average net yield and Extra+1 of 6 and 9%, respectively, compared to the control, a significant decrease in sensitivity to reddening/blushing but increased susceptibility to bacterial disease for untreated plants in the field.

Trial 2:

A similar trial as detailed above was repeated on endives (Cichorium intybus). In this case, two different varieties, both highly demanding in N requirements, were tested: Baccara (Hoquet) late type and Flexine (Vilmorin) very late type.

As shown in Table 3, the gross and net yields in chicons for 100 forced roots are on average significantly higher by 6% and 7% with the addition of glycine betaine at forcing compared to the control. However, the effect of glycine betaine treatment at forcing on the yielded mass Extra+1 is not significant. By contrast, the percentage of average Extra+1 by comparison to Net is 3 points lower and the difference although low is significant.

TABLE 3
Yields in average chicons for 100 forced roots
per treatment option at forcing.

| Treatment at | Gross | | Extra + 1 | Extra + 1 |
|---|---|---|---|---|
| forcing | (kg) | Net (kg) | (kg) | (%) |
| Control | 18.8 b | 16.6 b | 15.9 | 96 a |
| Glycine betaine | 20.1 a | 17.8 a | 16.5 | 93 b |
| Test F (5%) | HS | HS | NS | HS |
| CV (%) | 5 | 6 | 6 | 3 |

Trial 3:

Endives (Cichorium intybus variety Daufine (N tolerant, Vilmorin) were forced in a hydroponic nutrient solution (0.9 meq/l nitrate, 6.3 meq/l calcium, 0.2 meq/l magnesium, 0.7 meq/l sulfate). Glycine betaine (Greenstim®—97% of glycine betaine, Lallemand) was incorporated in the hydroponic nutrient solution in partial replacement of the ammoniacal nitrogen source. The following treatments were tested:

T1: Control with water and standard nutrient solution;

T2: glycine betaine (Greenstim) was incorporated in the hydroponic nutrient solution in replacement of the ammoniacal nitrogen source at a rate of 3.3 meq/L or 387 mg/L (formula C₅H₁₁NO₂−MM=117.2). The percentage of glycine betaine in nitrogen contribution is 16.52%;

T3: glycine betaine (Greenstim) was incorporated in the hydroponic nutrient solution in replacement of the ammoniacal nitrogen source at a rate of 6.6 meq/L or 774 mg/L (equivalent to twice the dose of T2). The percentage of glycine betaine in nitrogen contribution is 33.04%; and

T4: glycine betaine (Greenstim) was incorporated in the hydroponic nutrient solution in replacement of the ammoniacal nitrogen source at a rate of 13.2 meq/L or 1548 mg/L (equivalent to four time the dose of T2). The percentage of glycine betaine in nitrogen contribution is 66.08%.

The endives were forced under the following conditions in similar conditions as described in trial 1.

A completely random block design with three repetitions of 80 chicons was used. A heated water-bath with one vat per treatment was used.

Dry matter content of the roots during lifting and in the course of storage, chicon yields by commercial categories, susceptibility of chicons to post-harvest degradation after storage at 20° C. were evaluated 3 weeks after starting the forcing. Edging, reddening and axis growth were evaluated 11 days after storage in air. Bacterial disease was evaluated after 11 and 28 days of storage in closed bags.

Statistical comparisons were made by analysis of variance (one-way ANOVA) followed by a Tukey-Kramer post-test. P-values of <0.05 indicated statistical significance.

Results of trial 3:

As shown in Table 4, T2 and T3 significantly reduced the level of edging as compared to the control.

TABLE 4
Sensitivity of chicons to degradation in post-harvest conservation.

| | | | | Bacterial | |
|---|---|---|---|---|---|
| | | | Growth | disease | |
| | Banding/ | Reddening/ | of the | at day | at day |
| Treatments | Edging | Blushing | axis | 11 | 28 |
| T1 | 3.2 a | 0.1 | 0.5 ab | 0.2 | 1.8 |
| T2 | 2.4 b | 0.1 | 0.5 ab | 0 | 2.2 |
| T3 | 2.5 b | 0.1 | 0.4 b | 0 | 1.6 |
| T4 | 3.4 a | 0.0 | 0.9 a | 0 | 1.4 |
| Test F (5%) | HS | NS | S | NS | NS |
| CV (%) | 40 | 338 | 120 | 610 | 75 |

Compared to the control, the application of glycine betaine (Greenstim) to forcing at 387 mg/l (or 3.3 meq of nitrogen per liter) resulted in a significant decrease in their sensitivity to edging.

Doubling the concentration of glycine betaine (Greenstim) did not significantly alter the results compared to the control or a single dose.

Trial 4:

Endives (Cichorium intybus variety Flexine (N demanding) were forced in a hydroponic nutrient solution. Glycine betaine (Greenstim®—97% of glycine betaine, Lallemand) was incorporated in the hydroponic nutrient solution in replacement of the ammoniacal nitrogen source. The following treatments were tested:

T1: Control with water and standard nutrient solution;

T2: glycine betaine (Greenstim) was incorporated in the hydroponic nutrient solution in replacement of the N equivalent in the form of ammonitrate at a rate of 3.3 meq/L or 387 mg/L (formula C₅H₁₁NO₂−MM=117.2). The percentage of glycine betaine in nitrogen contribution is 16.52%;

T3: glycine betaine (Greenstim) was incorporated in the hydroponic nutrient solution in replacement of the N equivalent in the form of ammonitrate at a rate of 1.65 meq/L or 193 mg/L (equivalent to twice the dose of T2/2). The percentage of glycine betaine in nitrogen contribution is 8.24%; and

T4: glycine betaine (Greenstim) was incorporated in the hydroponic nutrient solution in replacement of the ammoniacal nitrogen source at a rate of 0.33 meq/L or 39 mg/L (equivalent to four time the dose of T2/10). The percentage of glycine betaine in nitrogen contribution is 1.67%.

The same protocol as described above for trial 3 was used.

As shown in Table 5, the highest chicory yields were obtained with treatments T2 and T3, i.e. with glycine betaine (Greenstim) at dose 1 of 386 mg/L and the dose ½ of 193 mg/L, i. e. 3.3 and 1.65 meq of nitrogen per litre. Indeed, the respective differences of 6 and 7% gross and 6 and 8% net compared to the reference without glycine betaine (Greenstim) are significant.

TABLE 5
Yields in average chicons for 100 forced roots per treatment at forcing

| | Brut | | Extra + I1 | | Dry matter |
|---|---|---|---|---|---|
| Treatments | (Kg) | Net (Kg) | (Kg) | (%)* | (%) |
| T1 control | 15.5 b | 13.7 b | 10.0 | 74 | 5.7 |
| without | | | | | |
| glycine | | | | | |
| betaine | | | | | |
| T2 Dose 1 | 16.4 a | 14.6 a | 11.4 | 78 | 5.5 |
| T3 Dose 1/2 | 16.5 a | 14.7 a | 11.1 | 76 | 5.4 |
| T4 Dose | 15.1 b | 13.3 b | 10.0 | 75 | 5.4 |
| 1/10 | | | | | |
| Test F (5%) | HS | S | NS | NS | NS |
| CV (%) | 3 | 4 | 9 | 5 | 5 |

As shown in Table 6, the results indicated that chicory fed with solutions at dose 1 and the ½ dose was less sensitive to bacterial growth than at dose 1/10th and this difference was significant despite the very high coefficient of variation of the results. Also, treatments T2 and T3 reduced the level of edging compared to the control.

TABLE 6
Sensitivity of chicons to degradation in post-harvest conservation

| | | | | Bacterial disease | |
|---|---|---|---|---|---|
| | Banding/ | Growth of | Reddening/ | at day | at day |
| Treatments | Edging | the axis | Blushing | 14 | 20 |
| T1 control | 3.9 | 0.4 | 0.0 | 0 | 0.8 ab |
| without | | | | | |
| glycine | | | | | |
| betaine | | | | | |
| T2 Dose 1 | 3.2 | 0.4 | 0.1 | 0 | 0.4 b |
| T3 Dose 1/2 | 3.3 | 0.4 | 0.1 | 0 | 0.4 b |
| T4 Dose | 3.5 | 0.1 | 0.1 | 0 | 1.2 a |
| 1/10 | | | | | |
| Test F (5%) | NS | NS | NS | — | HS |
| CV (%) | 31 | 196 | 348 | — | 116 |

While the invention has been described in connection with specific embodiments thereof, it will be understood that the scope of the claims should not be limited by the preferred embodiments set forth in the examples, but should be given the broadest interpretation consistent with the description as a whole.

Further aspects of the invention:
1. A method for reducing leaf necrosis of a plant comprising supplying to a plant in a hydroponic nutrient solution an effective amount of glycine betaine.
2. A method for enhancing plant productivity comprising supplying to a plant in a hydroponic nutrient solution a productivity enhancing amount of glycine betaine.
3. The method of paragraph 1 or 2, wherein said glycine betaine is incorporated as an additive to supplement a hydroponic nutritive solution which feeds the plant in the hydroponic system or the glycine betaine is administered to the irrigation water of said plant.
4. The method of paragraph 1, wherein said glycine betaine is in partial or total replacement of an inorganic nitrogen source in the hydroponic nutrient solution and wherein said reduction of leaf necrosis is equivalent or superior as compared to plant cultivated with a nutrient solution comprising an inorganic nitrogen source alone in absence of glycine betaine.
5. The method of paragraph 2, wherein said glycine betaine is in partial or total replacement of an inorganic nitrogen source in the hydroponic nutrient solution and wherein said plant productivity is equivalent or superior as compared to plant cultivated with a nutrient solution comprising an inorganic nitrogen source alone in absence of glycine betaine.
6. The method of any one of paragraph 1 to 5, wherein said plant is an endive or chicory.
7. The method of any one of paragraphs 1 to 6, wherein said glycine betaine is incorporated in the hydroponic nutrient solution during a forcing process.
8. The method of any one of paragraphs 1 to 5, wherein said glycine betaine is incorporated in the hydroponic nutrient solution in a concentration of between 0.75 meq/L to 20 meq/L.
9. The method of any one of paragraphs 1 to 2 or 4 to 8, wherein said amount of inorganic nitrogen source in the hydroponic solution is reduced by from 0.1% to 100% and replace by an equivalent amount of glycine betaine in terms of nitrogen supplied.
10. The method of paragraph 9, wherein said amount of inorganic nitrogen source in the hydroponic solution is reduced by at least about 0.1%, at least about 0.5%, at least about 1%, at least about 2% at least about 3%, at least about 4%, at least about 5%, at least about 6%, at least about 7%, at least about 8%, at least about 9%, at least about 10%, at least about 15%, at least about 20%, at least about 25%, at least about 30%, at least about 35, at least about 40%, at least about 45%, at least about 50%, at least about 55%, at least about 60%, at least about 65%, at least about 70%, at least about 75%, at least about 80%, at least about 85%, at least about 90%, at least about 95% or in totality.
11. The method of any one of paragraphs 1, 3, 4 and 6 to 10, wherein said leaf necrosis is reduced by at least 0.1%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, or more than 90% compared to plant cultivated with a nutrient solution comprising an inorganic nitrogen source alone in absence of glycine betaine.
12. The method of any one of paragraphs 2, 3 and 5 to 10, wherein said plant productivity is enhanced by at least 0.1%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, or more than 90% compared to plant cultivated with a nutrient solution comprising an inorganic nitrogen source alone in absence of glycine betaine.
13. Use of glycine betaine in a hydroponic nutrient solution to enhance plant productivity and/or to reduce leaf necrosis, wherein said glycine betaine is incorporated as an additive to supplement a hydroponic nutritive solution which feeds the plant in the hydroponic system or the glycine betaine is administered to the irrigation water of said plant and wherein the plant productivity is enhanced as compared to plant cultivated with a nutrient solution comprising an inorganic nitrogen source alone in absence of glycine betaine and/or the leaf necrosis is reduced as compared to plant cultivated with a nutrient solution comprising an inorganic nitrogen source alone in absence of glycine betaine.
14. Use of glycine betaine in a hydroponic nutrient solution to enhance plant productivity and/or to reduce leaf necrosis, wherein said glycine betaine is in partial or total replacement of an inorganic nitrogen source in a hydroponic nutrient solution and wherein the plant productivity is enhanced as compared to plant cultivated with a nutrient solution comprising an inorganic nitrogen source in absence of glycine betaine and/or the leaf necrosis is reduced as compared to plant cultivated with a nutrient solution comprising an inorganic nitrogen source alone in absence of glycine betaine.
15. The use of paragraph 13 or 14, wherein said use is to reduce leaf necrosis.
16. The use of paragraph 13 and 14, wherein said use is to enhance plant productivity.
17. The use of paragraph 13 or 14, wherein said plant is an endive or chicory.
18. The use of any one of claims 13 to 17, wherein said glycine betaine is incorporated in the hydroponic nutrient solution during a forcing process.
19. The use of any one of paragraphs 13 to 18, wherein said glycine betaine is incorporated in the hydroponic nutrient solution in a concentration of between 0.75 meq/L to 20 meq/L.

1. A method for reducing leaf necrosis of a plant comprising supplying to a plant in a hydroponic nutrient solution an effective amount of glycine betaine.

2. The method of claim 1, wherein the hydroponic nutrient solution comprises one or more nutrients and said glycine betaine is incorporated as an additive to supplement the one or more nutrients in the hydroponic nutrient solution which feeds the plant in a hydroponic system.

3. The method of claim 1, wherein the glycine betaine is the sole nutrient in the hydroponic nutrient solution, preferably wherein the hydroponic nutrient solution consists of water and glycine betaine.

4. The method of any one of claims 1 to 3, wherein said glycine betaine is in partial or total replacement of an inorganic nitrogen source in the hydroponic nutrient solution and wherein said reduction of leaf necrosis is equivalent or superior as compared to a plant cultivated with a nutrient solution comprising an inorganic nitrogen source alone in absence of glycine betaine.

5. The method of claim 4, wherein said amount of inorganic nitrogen source in the hydroponic nutrient solution is reduced by from 0.01% to 100% and replaced by an equivalent amount of glycine betaine in terms of nitrogen supplied, optionally wherein said amount of inorganic nitrogen source in the hydroponic solution is reduced by at least about 0.01%, at least about 0.1%, at least about 0.5%, at least about 1%, at least about 2% at least about 3%, at least about 4%, at least about 5%, at least about 6%, at least about 7%, at least about 8%, at least about 9%, at least about 10%, at least about 15%, at least about 20%, at least about 25%, at least about 30%, at least about 35, at least about 40%, at least about 45%, at least about 50%, at least about 55%, at least about 60%, at least about 65%, at least about 70%, at least about 75%, at least about 80%, at least about 85%, at least about 90%, at least about 95% or in totality.

6. The method of any one of claims 1 to 5, wherein said leaf necrosis is reduced by at least 0.1%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, or more than 90% compared to a plant cultivated with a nutrient solution comprising an inorganic nitrogen source alone in absence of glycine betaine.

7. A method for enhancing plant productivity comprising supplying to a plant in a hydroponic nutrient solution a productivity enhancing amount of glycine betaine.

8. The method of claim 7, wherein the hydroponic nutrient solution comprises one or more nutrients and said glycine betaine is incorporated as an additive to supplement the one or more nutrients in the hydroponic nutrient solution which feeds the plant in a hydroponic system.

9. The method claim 7, wherein the glycine betaine is the sole nutrient in the hydroponic nutrient solution, preferably wherein the hydroponic nutrient solution consists of water and glycine betaine.

10. The method of any one of claims 7 to 9, wherein said glycine betaine is in partial or total replacement of an inorganic nitrogen source in the hydroponic nutrient solution and wherein said plant productivity is equivalent or superior as compared to a plant cultivated with a nutrient solution comprising an inorganic nitrogen source alone in absence of glycine betaine.

11. The method of claim 10, wherein said amount of inorganic nitrogen source in the hydroponic nutrient solution is reduced by from 0.1% to 100% and replaced by an equivalent amount of glycine betaine in terms of nitrogen supplied, optionally wherein said amount of inorganic nitrogen source in the hydroponic solution is reduced by at least about 0.1%, at least about 0.5%, at least about 1%, at least about 2% at least about 3%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95% or in totality.

12. The method of any one of claims 7 to 11, wherein said plant productivity is enhanced by at least 0.1%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, or more than 90% compared to a plant cultivated with a nutrient solution comprising an inorganic nitrogen source alone in absence of glycine betaine.

13. The method of any one of claims 1 to 12, wherein said plant is a leafy vegetable, preferably wherein said plant is an endive or chicory.

14. The method of any one of claims 1 to 13, wherein said glycine betaine is incorporated in the hydroponic nutrient solution during a forcing process.

15. The method of any one of claims 1 to 14, wherein said glycine betaine is incorporated in the hydroponic nutrient solution at a concentration of between 0.75 meq/L to 20 meq/L (85 mg/L to 2350 mg/L), preferably between 0.75 meq/L to 7 meq/L (85 mg/L to 820 mg/L).

16. Use of glycine betaine in a hydroponic nutrient solution to enhance plant productivity and/or to reduce leaf necrosis, wherein:
(a) the hydroponic nutrient solution comprises one or more nutrients and said glycine betaine is incorporated as an additive to supplement the one or more nutrient in the hydroponic nutrient solution which feeds the plant in a hydroponic system; or
(b) the glycine betaine is the sole nutrient in the hydroponic nutrient solution, preferably wherein the hydroponic nutrient solution consists of water and glycine betaine,
and wherein the plant productivity is enhanced as compared to a plant cultivated with a nutrient solution comprising an inorganic nitrogen source alone in absence of glycine betaine and/or the leaf necrosis is reduced as compared to a plant cultivated with a nutrient solution comprising an inorganic nitrogen source alone in absence of glycine betaine.

17. Use of glycine betaine in a hydroponic nutrient solution to enhance plant productivity and/or to reduce leaf necrosis, wherein said glycine betaine is in partial or total replacement of an inorganic nitrogen source in a hydroponic nutrient solution and wherein the plant productivity is enhanced as compared to a plant cultivated with a nutrient solution comprising an inorganic nitrogen source in absence of glycine betaine and/or the leaf necrosis is reduced as compared to a plant cultivated with a nutrient solution comprising an inorganic nitrogen source alone in absence of glycine betaine.

18. The use of claim 16 or 17, wherein said use is to reduce leaf necrosis.

19. The use of claim 16 or 17, wherein said use is to enhance plant productivity.

20. The use of any one of claims 16 to 19, wherein said plant is a leafy vegetable, preferably wherein said plant is an endive or chicory.

21. The use of any one of claims 16 to 20, wherein said glycine betaine is incorporated in the hydroponic nutrient solution during a forcing process.

22. The use of any one of claims 16 to 21, wherein said glycine betaine is incorporated in the hydroponic nutrient solution at a concentration of between 0.75 meq/L to 20 meq/L (85 mg/L to 2350 mg/L), preferably between 0.75 meq/L to 7 meq/L (85 mg/L to 820 mg/L).
